(19) United States
(12) Patent Application Publication
(10) Pub. No.: US 2011/0198140 A1
(43) Pub. Date: Aug. 18, 2011

(54) METHOD AND DEVICE FOR THE OPERATION OF A HYBRID DRIVE OF A VEHICLE

(76) Inventors: Stefan Wallner, Mattsee (AT); Johannes Kaltenbach, Friedrichshafen (DE); Kai Bornträger, Langenargen (DE)

(21) Appl. No.: 12/808,633

(22) PCT Filed: Dec. 2, 2008
(86) PCT No.: PCT/EP2008/066600

§ 371 Date: Nov. 19, 2010

(30) Foreign Application Priority Data
Dec. 17, 2007 (DE) 102007055832.7

(51) Int. Cl. B60K 6/20

(52) U.S. Cl. 180/65.28; 903/902

(57) ABSTRACT

The invention relates to a method and a device for operating a hybrid drive (1) of a vehicle, comprising a drive train (2) that has a combustion engine (3), at least one electric machine (5), and a powershift transmission (7). The combustion engine (3) can be started from purely electromotive force during powershifting. In order to ensure a reliable starting process and a high degree of comfort during operation, a slip period during which at least one powershifting element of the powershift transmission (7) is in a state of slip during powershifting is adjusted at least during a signaled start of the combustion engine (3) by taking into account a progress over time of the start of the combustion engine (3). In a device for carrying out said method, means are provided for detecting and time-variably adjusting a slip of at least one powershifting element of the powershift transmission (7).

The invention concerns a process and a system for the operation of a hybrid drive in a vehicle according to the preamble of patent claim 1 and/or patent claim 12.

Hybrid drives are increasingly important in vehicle manufacture due to their potential for reducing emissions of hazardous materials and energy consumption. Such vehicles have different types of drive power sources, whereby combinations of internal combustion engines and electric motors are advantageous because they can utilize the range and power advantages of internal combustion engines on the one hand and the flexible applications of electric motors on the other as sole or auxiliary power source or as a starter/generator and a generator for electrical power and recovery.

There is a basic distinction between so-called series hybrids and parallel hybrids as hybrid topologies for vehicle drives. Such drive arrangements are already known and are continually further developed. In the series hybrid, the drive motors are connected one after the other in terms of drive technology. Here, the internal combustion engine, for example a diesel engine, serves as the drive for a generator that in turn drives an electric motor. The vehicle is exclusively driven by the electric motor. The internal combustion engine is decoupled from the drive wheels and can therefore always be operated a single operating point, that is, at a certain torque and constant speed. This drive concept is suitable for buses in short-range city traffic, for example, where an operating point can be chosen at which the efficiency of the internal combustion engine is as high as possible, while hazardous waste emission, fuel consumption, and noise lie in a favorable range. On the other hand, the series hybrid has the disadvantage that the efficiency of the drive is restricted due to multiple conversions between mechanical and electrical power.

In contrast, parallel hybrid drive trains, due to an arrangement of drive train assemblies that is parallel in terms of power flow, offer in addition to the overlapping of drive torques the option of control using purely internal combustion drive or purely electrical drive. Basically, in the parallel hybrid the internal combustion engine can largely be operated at its optimum torque by loading and/or supporting one or more electrical motors, so that the maximum efficiency of the internal combustion engine can be used effectively. This support of the internal combustion engine reduces fuel consumption on average. Since temporary increases in power requirements in so-called “boost mode”, for example during passing, permit the drive powers to be added together, the internal combustion engine can be comparatively small, saving weight and space with nearly no penalties in terms of vehicle performance or comfort, with resulting savings in emissions and cost. The electric motor can also function as an integrated starter generator (ISG) to start the internal combustion engine using a clutch. The electrical motor is also used in generator mode to charge an electrical power store and can be used for recovery. Any type of vehicle transmission can be used to vary the gear transmission ratio of the drive to the driven axis.

The goal of numerous developments in hybrid drive company is operational strategies on the one hand to make use of existing hybrid components depending on the driving situation while largely considering driver wishes, while using them in as effective and energy-saving manner as possible while preserving a high degree of driver comfort. Some examples are listed below.

DE 10 2004 043 589 A1 includes such an operating strategy in a parallel hybrid drive train, for example in combination with the 6HP26 6-gear automatic transmission known from the applicant's production series, in which a target charge state of an electrical energy store is determined based a more sporty or more economic driving style. The drive performance is distributed over the hybrid assemblies in accordance with the momentary drive requirements of the driver in such a way that this target charge is maintained. A particularly sporty driving style requires the energy store to be maintained close to full capacity at all times in order to provide the total power of the drive assemblies during boosting. A more economical driving style, on the other hand, often requires the energy store to be exhausted in order to utilize the incoming recovery power effectively to charge the store.

WO 2006 111 434 A1 discloses a process by means of which an electric motor and an internal combustion engine generate a required target torque together, whereby a momentary torque reserve is taken into consideration in the electric motor in order to minimize a given torque reserve in the internal combustion engine.

WO 2007 020 130 A1 discloses a process for recovery in a hybrid vehicle whereby the portion of braking torque in the electric motor during speed reduction is coordinated with a brake pressure exerted by the driver.

U.S. Pat. No. 7,174,980 B2 discloses a process for the control of a hybrid drive in which an electric motor is used to prevent sudden changes in drag torque, and depending on requirements, influencing the drag torque characteristic of the entire hybrid drive.

DE 10 2005 044 828 A1 describes a process for the calculation of the optimum operating point of a hybrid drive, whereby a torque requested by the driver on the one hand and a dynamic behavior of existing vehicle assemblies on the other hand, e.g. a so-called turbo gap, are taken into consideration. A optimization algorithm is suggested in which previously determined parameters and current conditions such as the momentary position of the accelerator and the current speed of the vehicle are used to affect variables such as the distribution of torque between drive assemblies and the gear transmission ratio.

DE 10 2005 044 268 A1 discloses a process in which the charge state of an energy store and/or an energy flow (drive power/electric power) in the vehicle is regulated depending on a cost function for energy consumption or hazardous waste emission in order to increase the efficiency of a hybrid drive.

In DE 699 32 487 T2, a process is described for the regulation and monitoring of the charge state of an electrical energy store in a hybrid vehicle, whereby even in case of insufficiency recovery in certain driving situations, for example in case of repeated successive acceleration and braking or in case of driving up a slope that does not immediately follow a downhill slope, sufficient charge in the store is assured.

Finally, DE 10 2005 049 458 A1 recommends a forward-looking strategy in the operation of a vehicle with a hybrid drive, in which digital maps, location systems, and location-specific speed distributions stored in time/space traffic patterns are all used to make decisions about the engagement or disengagement of a hybrid assembly for the specific stretch of road.

On the other hand, customers and vehicle manufacturers desire hybrid drive trains that can be implemented in new or existing vehicle models with the smallest possible extra space requirements, the lowest possible complexity, and the lowest possible cost and design effort.

For parallel hybrid vehicles, different drive train arrangements are already known. In one common design, disclosed for example in US 2005 022 1947 A1, the internal combustion engine can be coupled with an electric motor using a first clutch. The electric motor can be connected to a transmission using a second clutch. It is also possible, as shown in DE 10 2004 043 589 A1 already cited, to place a second electric motor between the second clutch and the transmission. Instead of a direct connection between the internal combustion engine and transmission or a direct power connection through a clutch, the electric motor can also be connected to the drive train through a planetary gear. This permits the electric motor to act as an electrodynamic moving-off element (EDA), whereby a conventional clutch can be eliminated. Such a hybrid system with an EDA is known, for example, in combination with the automatic AS Tronic transmission from the applicant's production series, and is particularly suitable for utility vehicles in city public transit applications with frequent starting, braking, and shifting operations.

A particularly simple hybrid drive train, on the other hand, is disclosed by DE 10 2005 051 382 A1. In this arrangement, only a friction-resistant or particularly cost-effective and compact shaped clutch is provided that can be used to connect an internal combustion engine with an electric motor. No second clutch between the electric motor and a downstream transmission is required. The electric motor can thus directly exert a positive (motor operation) or negative (generator operation) torque on a transmission input shaft for the gear shifting assembly. The transmission can be an automatic power-shift transmission, for example, that is a discrete or continuous transmission in which changes in gear transmission ratio are largely free of power interruptions, that is, can take place under load using automatically controlled shifting elements such as lamellar clutches or band brakes.

In a hybrid vehicle, effortless switching between drive modes during driving is particularly important. Starts of the internal combustion motor from pure electric drive, particularly frequent in city driving, should take place reliably and conveniently, where possible without jerks in the drive train. A switching strategy and a hybrid operation strategy can be correlated in such a way that a shift requirement coincides with a motor start request in certain operating situations.

To start the internal combustion motor in electric drive using the process described in DE 10 2005 051 382 A1, the transmission must first be in a neutral position or be placed into neutral. The clutch is then engaged in the closing direction, so that the electric motor exerts a positive torque on the internal combustion engine in its preferred rotational direction, starting it. The second clutch can be omitted, since the neutral position largely decouples the internal combustion engine from the take-off shaft of the transmission during the start process. The disadvantage of this process is that the forward motion of the vehicle can be unnecessarily slowed during drive switchover due to the neutral gear position. Engagement of a desired gear transmission ratio can only take place after the internal combustion engine starts.

In a process proposed by US 2005 022 1947 A1 for a hybrid vehicle with a multi-step transmission and a conventional arrangement with two clutches, on the other hand, the internal combustion engine can be started during a change in gear transmission ratio. A start/stop function is described in which the internal combustion engine is turned off and started again by an electric motor. In a stop step, a controller disconnects the internal combustion engine from the drive train using a clutch on the internal combustion engine side and stops it, when specific stopping conditions occur, for example when slowing at a traffic light or in a traffic jam. On the subsequent start step, the electric motor initially drives the vehicle with a first gear transmission ratio engaged. Then the controller changes (increases) the gear transmission ratio when specific operating conditions occur, while simultaneously the electric motor is disconnected from the transmission using the transmission clutch and the internal combustion engine clutch is engaged, so that the internal combustion engine is started by the electric motor. After the start is complete, the internal combustion engine is connected to the transmission by the transmission clutch, so that the internal combustion engine drives the vehicle, either alone or in combination with the electric motor. The restart process for the internal combustion engine can take place without noticeable jerks for the driver using this start sequence. The change in gear ratio in the transmission during the starting process for the internal combustion engine itself is not described in the publication in more detail.

An internal combustion engine start during changes in the gear transmission ratio in a hybrid vehicle with a power shift transmission, however, may prove problematic under certain circumstances, or at least reduce the driver's comfort, since power shifting is determined by the so-called slack time. In a power shift transmission there is generally an engaging shifting element (shift clutch) and a disengaging shifting element (shift clutch). In the meantime, in the so-called slack time, one or both shift clutches are in slack mode. During this slack time the take-off torque of the transmission is determined by the resulting clutch torque of the shift clutches. The take-off is thus largely decoupled from the transmission input and thus from the drive assemblies, whereby the start of the internal combustion engine can take place particularly conveniently during the slack time without jerk in the drive train. However, a disadvantage of this process is that in conventional power shift transmissions, shift control generally provides a fixed time for shifting the clutches internal to the transmission that is as short as possible. This period may not be sufficient to start the internal combustion engine, so that the transmission input may be connected to the transmission output in the new gear transmission ratio too early.

In this context, the object of the invention is to specify a process and system for the operation of a hybrid drive that, when starting an internal combustion engine during purely electric operation during a power shift of a power shift transmission, ensures a reliable start process and simultaneously a high degree of operating comfort.

The solution of this task results from the characteristics of the independent claims, while advantageous embodiments and further development of the invention can be found in the subordinate claims.

The invention is based on the recognition that in a hybrid vehicle with a power shift transmission, the transition from electric operation to internal combustion operation during a transmission shift can be carried out reliably and comfortably by adapting the slack time of the transmission to the starting process of the internal combustion engine.

The invention thus assumes a process for the operation of a hybrid drive of a vehicle with a drive train that has an internal combustion engine, at least one electric motor, and a power shift transmission, whereby the internal combustion engine can be started during purely electric operation during a power shift. To solve the task, the invention also provides that a slack time period, in which at least one power shift element of the power shift transmission is in slack time during a power shift, is adjusted at least during a signaled start of the internal combustion engine, taking the timing of the start process of the internal combustion engine into consideration.

In a system according to the invention for the operation of a hybrid drive with the aforementioned characteristics, means are provided for the execution of the process, for the detection and time-variant adjustment of the slack time of at least one power shift element of the power shift transmission.

“Power shift transmission” means an automatically shifting transmission that shifts with at least nearly no interruption in driving force. Such transmissions can for example be conventional automatic transmissions, but also automated double-clutch transmissions. “Power shift elements” mean the lamellar clutches, lamellar brakes, or band brakes usually used in power shift transmission for the moving in and out, or engagement and disengagement, of the corresponding transmission elements.

The invented process can basically be used in all types of land, water, and air vehicles with such parallel hybrid drive trains.

By adjusting, and particularly extending, the slack time period of the transmission, also called the slack time hereinafter, in order to start the engine it is ensured that the take-off of the transmission is decoupled from the drive until the internal combustion engine has been started, so that the engine start cannot cause jerks in the drive train. In such a start process, the operating comfort and functional reliability of the hybrid drive are thus reproducible during assembly transition.

Largely only minor changes are required to the existing shifting process to achieve this, a software change in the associated transmission controller. The slack time in the shifting elements is preferably extended only as long as necessary, that is, concomitant with requirements.

The internal combustion engine is preferably started during a power shift if a shift is already specified by a shifting strategy in the transmission controller and simultaneously the hybrid operation strategy requires the internal combustion engine to be started. However, the command to start the internal combustion engine can also always be started by direct driver request, for example using an accelerator position gradient, or indirectly, for example using a shift request by the driver after which an engine start is requested.

To adjust the slack time, the following particularly advantageous variants can be provided:

In the simpler variant, the slack time period can be extended by a fixed time after a signaled start of the internal combustion engine, that is, each time an internal combustion engine start is planned in the power shift.

More exact adjustment is permitted by means of adaptation of the slack time period to the starting time of the last engine start carried out, meaning that the slack time period for a signaled start of the internal combustion engine is adapted to the start behavior of the last start carried out.

Instead of a stored specification such as that used in the two variants cited above, a dynamic adaptation of the slack time to the current start process can also be provided, whereby a synchronization of the slack phase in the power shift transmission with the engine start and thus particularly exact adaptation of the slack time is enabled. Different operating parameters of the drive train and/or the vehicle are recorded over time, and the power shift transmission and/or the slack time are correspondingly adapted. Particularly suitable operating parameters for this include the current speed trend and the injection time of the internal combustion engine during the start process. Furthermore, position trends controlled by a clutch controller (stationary point, application point, carry point, closure point) for a disengagement clutch implemented as a friction clutch between the internal combustion engine and the electric motor and/or the power shift transmission can be taken into consideration in the establishment of the form-fitting connection to the electric motor.

Finally, it can be provided that the power shift element(s) participating in the change in gear ratio are kept slack during the starting process until a signal is received indicating that the internal combustion engine is running after a successful start. In this particularly simple variant, there is no concrete determination of the slack time. Rather, an open slack time is selected, whereby a termination signal concludes the slack phase of the transmission. This can conveniently include a safety function to end the transmission slack if the internal combustion engine fails to start or if the start process is canceled.

In practice, the process according to the invention is always used to extend the slack time in comparison with the conventional slack time. However, in principle the slack time could also be shortened in the case that an engine start could be completed before the slack time normally provided by the transmission controller elapses. For this case, it is practical to provide a minimum slack time to ensure smooth, low-wear gear shifts at all times.

In general, regardless of the engine start actually provided, a standard fixed slack time can be specified within which a start of the internal combustion engine can be completed in any case. However, this would unnecessarily lengthen the power shift time in all power shifts in which the engine is not started.

To clarify the invention, the description of a drawing of an embodiment is attached. In

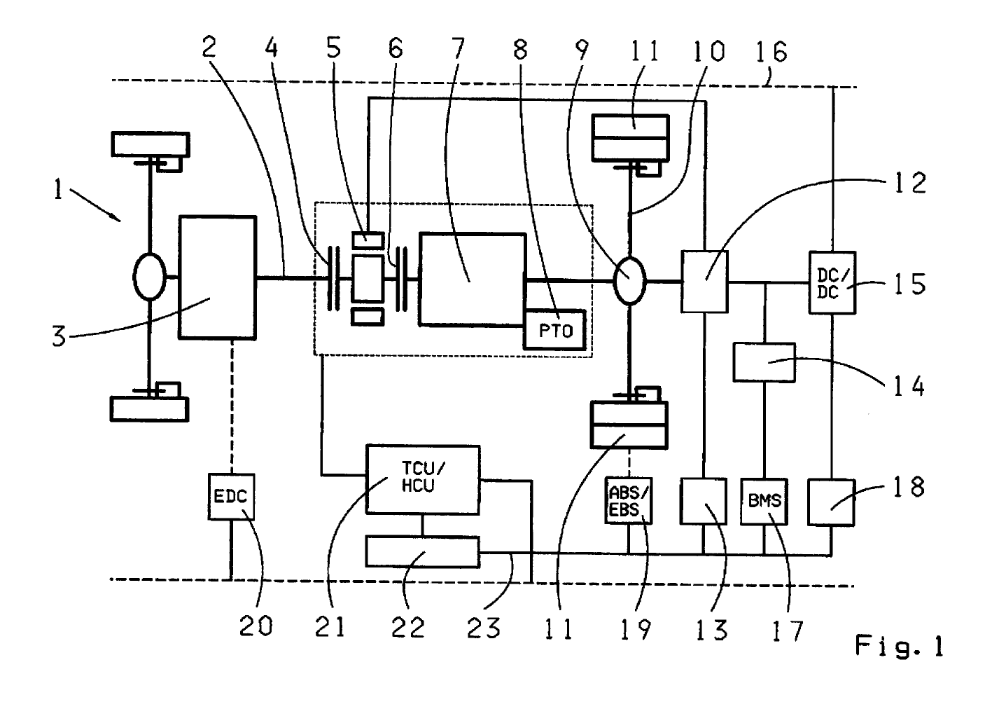

FIG. 1, this shows a schematic representation of a hybrid drive for performance of a process according to the invention.

FIG. 1 thus shows a schematic of a vehicle hybrid drive 1 with a parallel hybrid drive train 2, as might be provided for a utility vehicle, for example (truck, bus, specialized vehicle). The structure of such a drive train 2 is already familiar to the expert. The significant feature for the invention is a controller for this drive train 2 according to the invention. Drive train 2 has an internal combustion engine 3, for example a diesel engine, which can be connected to an electric motor 5 by means of a first clutch 4 implemented as a disengagement clutch. The electric motor 5 can in turn be connected to a power shift transmission 7, for example a conventional stepped automatic transmission, by means of an optional second clutch 6 implemented as a starting clutch. The function of the second clutch 5 can also be replaced by transmission-internal clutch elements. Downstream of power shift transmission 7, an auxiliary take-off (PTO: Power Take-Off) 8, not explained further, can also be provided. Transmission 7 and a differential 9 can also be used in a conventional manner to direct the applied torque of hybrid drive 1 to a drive axle 10 and further to the drive wheels 11.

Depending on the operating situation, electric motor 5 can be operated as an electrical drive assembly or as a generator. To this end, it is connected to an electrical inverter 12 that can be controlled by an inverter controller 13. Through inverter 12, electric motor 5 is connected to an electrical drive energy store 14, for example a 340V high-voltage battery. In motor operation, electric motor 5 is supplied by energy store 14. In generator operation, that is, when driven by internal combustion engine 3 and/or in recovery mode, the energy store 14 is charged by electric motor 5. Furthermore, electric motor 5 functions as an integrated starter generator (ISG) to start internal combustion engine 3.

The high-voltage circuit of energy store 14 and/or the controller connected to it are connected to an on-board network (24V or 12V) 16 through a bidirectional direct-current converter (DC/DC). Energy store 14 can be monitored and controlled by a battery management system 17 with respect to its state of charge (SOC). Direct-current converter 15 can be controlled by a direct-current converter controller 18. Moreover, a controller 19 is provided for brake regulation functions not explained in further detail, particularly an anti-lock brake system (ABS) and/or an electronic brake system (EBS) as well as another controller 20 for electronic diesel control (EDC) for internal combustion engine 3, implemented as a diesel engine, for example. The controllers listed individually can also at least partly be combined into a single controller.

Moreover, an integrated control system 21 is provided, primarily combining the functions of a transmission control unit (TCU), a hybrid control unit (HCU), and different operating functions. The specific drive energy distribution and functional control of the individual components of the hybrid drive can be controlled by means of a central strategic unit 22, which is preferably connected by means of a data bus 23 (e.g. CAN) to control system 21 and the relevant controllers 13, 17, 18, 19.

In this hybrid drive 1, to perform the process according to the invention, when starting internal combustion engine 3 from purely electric travel during a transmission gear shift of power shift transmission 7, a slack time of the transmission-internal shifting clutches (not shown) participating in the power shift is adjusted.

To start internal combustion engine 3, control system 21 is controlled by strategic unit 22 in such a way that the disengagement clutch 4 on the internal combustion engine side is closed and the crankshaft of self-starter 3 is turned by means of a rotor shaft of electric motor 5 until internal combustion engine 3 starts during appropriate injection of fuel.

During the start process, the shift procedure is influenced in such a way that the slack time of the transmission-internal shifting elements is in any case sufficient for the start of the internal combustion engine 3. To this end, each time the strategic unit 22 indicates a start of the internal combustion engine 3 during a power shift, the slack time can be extended. For advantageous static adjustment variants, the slack time can be given a stored value or the start behavior of the last engine start can be used.

In an advantageous dynamic adjustment variant, the slack time can be adapted to the actual starting behavior of the internal combustion engine 3 using relevant recorded and further processed operating parameters, particularly the speed trend of the internal combustion engine, the injection timing, and the closing trend of disengagement clutch 4.

In a further dynamic adjustment variant, the slack time for the shift clutches involved is terminated when a motor start function reports that the start is complete.

### LIST OF REFERENCE NUMBERS

1 Hybrid drive
2 Drive train
3 Internal combustion engine
4 First clutch
5 Electric motor
6 Second clutch
7 Power shift transmission
8 Auxiliary transmission
9 Differential
10 Axle
11 Wheel
12 Electric inverter
13 Control unit
14 Energy store
15 Direct-current converter
16 On-board network
17 Control unit
18 Control unit
19 Control unit
20 Control unit
21 Control system
22 Strategic unit
23 Data bus

1. A process for the operation of a hybrid drive (1) of a vehicle, with a drive train (2) comprising an internal combustion engine (3), at least one electric motor (5), and a power shift transmission (7), whereby the internal combustion engine (3) can be started during purely electric travel during a power shift, characterized by the fact that a slack time period in which at least one power shift element of the power shift transmission (7) is in slack during a power shift is adjusted at least after a signaled start of the internal combustion engine (3) taking a temporal start behavior of the internal combustion engine (3) into consideration.

2. The process according to claim 1, characterized by the fact that a start of the internal combustion engine (3) is determined by a hybrid operation strategy.

3. The process according to claim 1, characterized by the fact that a start of the internal combustion engine (3) is introduced by a request from the driver.

4. The process to claim 1, characterized by the fact that the slack time period during a signaled start of the internal combustion engine (3) is extended by a specified fixed period of time.

5. The process according to claim 1, characterized by the fact that the slack time period during a signaled start of the internal combustion engine (3) is adapted to the start behavior of the last start carried out.

6. The process according to claim 1, characterized by the fact that the slack time period during a signaled start of the internal combustion engine (3) is dynamically adapted to the current start process using currently recorded operating parameters.

7. The process according to claim 6, characterized by the fact that as a first operating parameter for dynamic slack time adaptation the speed trend of the internal combustion motor (3) is taken into consideration during the start process.

8. The process according to claim 6, characterized by the fact that that as a second operating parameter for dynamic slack time adaptation the position trend of a clutch (4) connecting the internal combustion engine (3) with the drive train (2) is taken into consideration during the start process.

9. The process according to claim 6, characterized by the fact that as a third operating parameter for dynamic slack time adaptation, at least one injection time point for the internal combustion engine (3) is taken into consideration during the start process.

10. The process according to claim 1, characterized by the fact that at least one power shift element is kept in slack during the start process until a signal is detected indicating that the internal combustion engine (3) is running after a successful start.

11. The process according to claim 1, characterized by the fact that a safety function is provided that terminates the transmission slack time in the case that the start of the internal combustion engine (3) fails or is canceled.

12. A system for the operating of a hybrid drive (1) of a vehicle with a drive train (2) comprising an internal combustion engine (3), at least one electric motor (5), and a power shift transmission (7), whereby the internal combustion engine (3) can be started from purely electric travel during a power shift, characterized by the fact that that means are provided for the detection and time-variable adjustment of a slack time for at least one power shift element of the power shift transmission (7).
